(19) United States
(12) Patent Application Publication
(10) Pub. No.: US 2002/0107074 A1
(43) Pub. Date: Aug. 8, 2002

(54) Method and system of selling merchandise through a virtual shop with an electronic lottery

(76) Inventor: Hong-Kil Lee, Seoul (KR)

Correspondence Address: David Tichane, Registered Patent Attorney, 979 Pinto Palm Terrace, # 24, Sunnyvale, CA, 94087, US

(21) Appl. No.: 10/071,754

(22) Filed: Feb. 6, 2002

(30) Foreign Application Priority Data
Jun. 7, 2000 (KR) PCT/KR00/00591

(51) Int. Cl. G06F 19/00

(52) U.S. Cl. 463/42

(57) ABSTRACT

The present invention relates to a lottery type selling method and apparatus through a virtual shopping mall established through Internet. The lottery type selling method comprises the steps of: establishing a virtual shopping mall; registering a sales product at the mall; selling a lottery through a consumer's terminal connected to the server; confirming whether or not a total sales amount of the lotteries; stopping sales of the lottery and publicly announcing a lottery date; carrying out the lottery for the corresponding product and publicly announcing a winner; and delivering the product to the winner. The invention establishes the virtual shopping mall, thereby decreasing merchandise distributing cost, and also can provide consumers with the opportunity to purchase a high price product through a low price lottery right.

### Cross-Reference

Applicant claims priority from PCT application PCT/KR00/00591 filed Jun. 7, 2000 which named the United States.

### TECHNICAL FIELD

The present invention relates to a lottery type selling method and apparatus of products registered at a virtual shopping mall which has been established using a computer, and more particularly, to a lottery type selling method and apparatus through a virtual shopping mall in which a lottery ticket is sold, a corresponding product is provided to a prize winner, and payment of the corresponding product is provided using total payment of the lottery tickets on the corresponding products. The present invention is to provide a new electronic commerce method and apparatus, and it contributes to activity of the electronic commerce.

### BACKGROUND ART

Regarding conventional electronic commerce, there are cyber shopping mall methods on the Internet, cyber auction methods, and reverse auction methods. The conventional cyber shopping mall substitutes a virtual shopping mall for a real shopping mall for the sales of a product by using computer technology. The consumer accesses the virtual shopping mall on-line through the Internet, searches a desired product through the consumer's terminal, carries out a purchasing order, and makes a payment. Likewise, the cyber auction tenders for a product at a virtual auction field made by computer instead of a real auction field. The reverse auction method allows a consumer to announce publicly the consumer's desired product, type, price, payment settlement method, etc., on the virtual auction field, multiple sellers who perceive the public announcement to provide the condition tendered, and the highest condition provider to knock down the article. These conventional electronic commerce methods provide conveniences that permit consumers to purchase desired products on-line without direct visits to the real shopping mall or the real auction field.

However, because these conventional methods require the consumer to assume a total payment of the product, only a consumer having purchasing ability can participate in commerce. Accordingly parties related to the dealings are limited. Further, as Internet homepages for virtual shopping malls and virtual auctions increase, competition between respective Internet sites is heated, resulting in lower profitability.

To overcome these problems, conventional methods try to hold various events or gift festivals to attract consumers to use the virtual shopping mall. However, these events or gift festivals increase management costs of the virtual shopping malls, so that a vicious circle of decreased profitability results.

### SUMMARY OF THE INVENTION

Accordingly, the present invention has been devised to solve the above problems. It is an object of the present invention to provide a lottery type selling method and apparatus in which a lottery right is sold corresponding to a product which is selling at a virtual shopping mall. A purchase of the corresponding product is paid for from the total sales amount of the lottery rights. The corresponding product is provided to a winner who is decided through a lottery among purchasers of the lottery right. Thus the present invention allows consumers an opportunity to purchase desired products for the small cost of a lottery right, and accordingly increases the volume of electronic commerce.

To accomplish the aforementioned object of the present invention, there is provided a lottery type selling method, the method comprising the steps of: establishing a virtual shopping mall on a server; registering a sales product at the virtual shopping mall; selling a lottery chance corresponding to the product through a consumer's terminal connected to the server through a communication network; confirming whether or not a total sales amount of the lottery chances corresponding to the product reaches a target amount at the server; if it is confirmed that the total sales amount reaches the target amount, stopping the sale of lottery chances and publicly announcing a lottery date; carrying out the lottery for the corresponding product and publicly announcing a winner; and delivering the product to the winner.

Also, a lottery type selling apparatus of the present invention comprises: a product database including product information of a virtual shopping mall; a lottery database including lottery information of each of products; a storage unit for storing a consumer database including information related to a lottery purchaser; and a server including a means for establishing and managing the virtual shopping mall, selling the lottery according to a purchase request transmitted from a consumer's terminal, and a means for confirming a sales amount of the lottery corresponding to the product, when the sales amount of the lottery arrives at a target amount, stopping the sale of lottery chances, and publicly announcing a lottery date, wherein the consumer's terminal includes a means for transmitting information including the purchase request, and a means for receiving information from the server and displaying the information.

### BRIEF DESCRIPTION OF THE DRAWINGS

FIG. 1 is a schematic view of a lottery type selling apparatus using a virtual shopping mall in accordance with the present invention;

FIG. 2 is a schematic view of a lottery type selling method using a virtual shopping mall in accordance with the present invention;

FIG. 3 is a flow chart showing a flow of a membership access and product search in the lottery type selling method using the virtual shopping mall in accordance with the present invention;

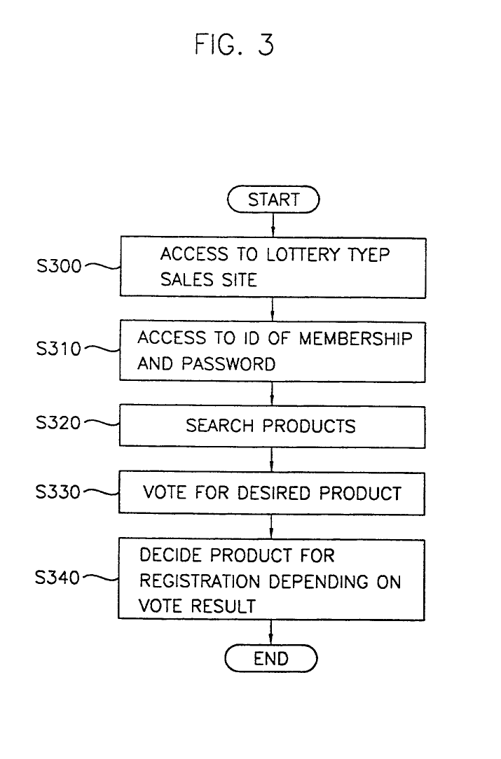

FIG. 4 is a schematic view showing one embodiment of the present invention in which a registered product is displayed on a consumer's terminal connected to a server in the lottery type selling method using the virtual shopping mall;

FIG. 5 is a schematic view showing one embodiment of the present invention in which a purchase breakdown of a product lottery right is displayed on a consumer's terminal connected to a server in the lottery type selling method using the virtual shopping mall; and

FIG. 6 is a schematic view showing one embodiment of a picture that is displayed on the server upon registering a product in the lottery type selling method using the virtual shopping mall in accordance with the present invention.

### BEST MODE FOR CARRYING OUT THE INVENTION

Hereinafter, there are more fully described preferred embodiments of the present invention with reference to the accompanying drawings.

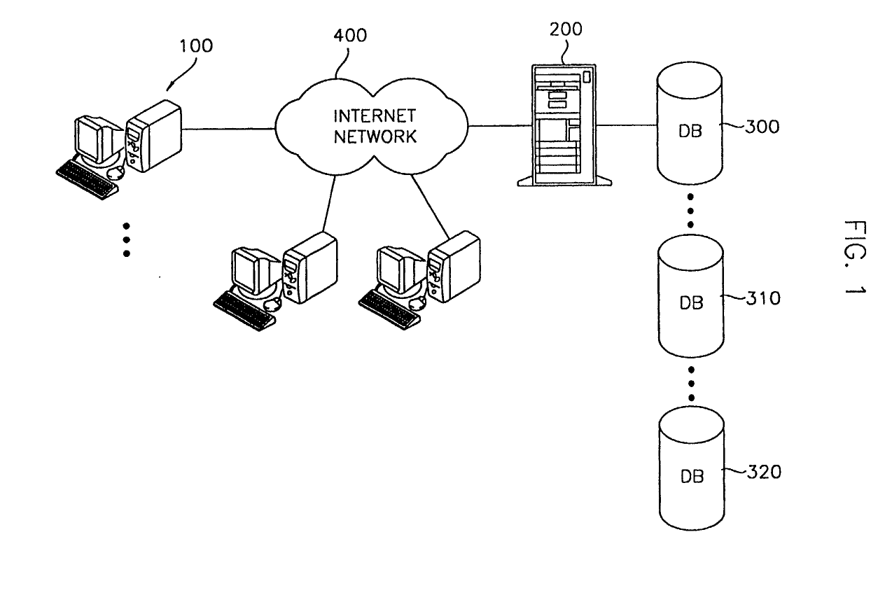

FIG. 1 is a schematic view of a lottery type selling apparatus using a virtual shopping mall in accordance with the present invention

Referring to FIG. 1, a lottery type selling apparatus using a virtual shopping mall includes storage units 300, 310, and 320 for storing various types of databases, a server 200 for establishing and managing the virtual shopping mall, and a consumer terminal 100 such as a personal computer or an Internet phone connected to the server 200 through a telecommunication network, such as Internet or radio data network or the like.

The storage units 300, 310, 320 are to store various types of databases. The databases manage information necessary for the lottery sale. These databases may be constituted to include the following elements: a product database including fields such as types of products registered at the virtual shopping mall for sales/name/brief description/photograph/manufacturer/price/issuance amount of lottery right/price of lottery right/lottery date/sales rate of lottery right/target sales rate of lottery right and the like; a lottery right database including fields such as a corresponding product to lottery right/lottery number/purchaser name/sales date and the like; a consumer database including fields such as lottery purchaser's name/resident registration number/address/contact phone number/E-mail/settlement method and the like; a member database including fields such as member's name of a virtual shopping mall/address/contact phone number/settlement method/ID/Password/classification code/purchase breakdown of lottery right/winning breakdown/job/position and the like/and a lessee database including fields such as a lessee's name of a virtual shopping mall/address/contact phone number/type of sales product/rental period/rental range/rent and the like.

The server 200 establishes and manages the virtual shopping mall. The shopping mall can be made to operate on the server by using a computer language of HTML, Java, Flash or the like. The server 200 receives types of sales products, names, brief description, photographs, manufacturer, price, issuance amount of lottery right, price of lottery right, targeted sales amount, and the like as inputs, writes these input data in the product database, and links the product database to the virtual shopping mall.

Accordingly, consumers access the virtual shopping mall through their respective terminals 100 connected to the server, and click a desired product on a list to thereby obtain information on the desired product. In order to provide convenience during use of the shopping mall, the server establishes the virtual shopping mall. When the consumer requests information on a specific product, the server transmits the information to the consumer's terminal with reference to the storage units and the product database. Further, the server receives a purchase request of the lottery right transmitted from the consumer's terminal, updates the database of the corresponding lottery right to complete the sale of the lottery right, and updates a sales rate of the lottery right of the corresponding product database. If the updated sales of the lottery rights reaches a targeted sales level, the server stops selling the lottery right. After the sale of the lottery right ends, the server decides and publicly announces the lottery date. After the lottery is completed, the server publicly announces a winner, thereby completing the lottery type sale of the corresponding product.

The consumer terminal 100 such as a personal computer or a handheld Internet phone is connected to the server through a communication network such as Internet, radio data network or the like. Accordingly, a consumer can carry out a bidirectional telecommunication for obtaining product information through these terminals, or purchasing a lottery right of a desired product on-line.

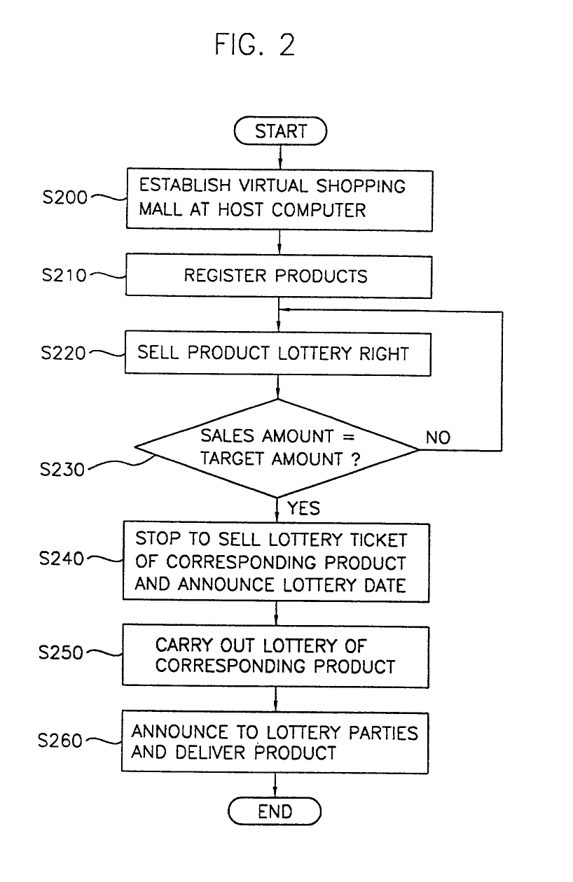

A lottery type selling method using the virtual shopping mall is carried out by the sequence shown in FIG. 2. First, in step S200, a virtual shopping mall is established on the server using a computer language such as HTML, Java, Flash or the like. In other words, the virtual shopping mall is made in such a state in which a registration of a sales product is allowed, and the registered product is displayed on the Internet.

In step S210, products to be sold by the lottery type selling method are registered at the established virtual shopping mall. At this time, there is input information to be used in the respective fields of the product database, such as types of products, names, brief description, photographs, manufacturer, prices, issuance amount of lottery right, price of lottery right and the like. Based on the input information, the server creates an information database of a corresponding product at the storage unit, registers the created information database at the virtual shopping mall, and displays the corresponding products when a consumer accesses to the virtual shopping mall.

The consumer accesses the virtual shopping mall through the terminal connected to the server using a communication network. The consumer views information about a specific product, and transmits a purchase request for the lottery right to the server through the terminal. The consumer request signal includes information such as the purchaser's name, address, contact phone number, settlement method and the like. With reference to the information contained in the consumer request signal, the server creates a lottery right database of corresponding products, and enters the corresponding information in the respective fields. Also, with reference to the settlement method out of the purchaser's information, the server confirms whether or not sales money of the lottery right is paid. For instance, in case that the selected settlement method is an electronic fund transfer from an account to another account, the server confirms whether or not the payment is possible by requesting a fund transfer to a corresponding account, or in case that the selected settlement method is a credit card, the server confirms whether or not an approval of the credit deal is possible. As a consequence of the confirmation, in case that the payment of the lottery right is completed, the server transmits a purchase completion signal of the lottery right to the consumer terminal. At the same time, the server updates a field of the sales rate of the lottery right of the corresponding product database into information after the sale, and displays an updated information of the corresponding product on the virtual shopping mall. Thereby, a sale for one sheet of the lottery right is completed. (S220)

After one sheet of lottery right has been sold, the server compares the field of the sales rate of the lottery right of the corresponding product database with a targeted sales rate. If the sales rate of the lottery right arrives at the targeted sales rate, the server stops selling the lottery right of the corresponding product (S240), decides the lottery date of the corresponding product, and fills the lottery date in the lottery date field. If the sales rate of the lottery right does not arrive at the targeted sales rate, the server continues to sell the lottery right of the corresponding product. (S230)

A winner of the corresponding product publicly is decided on the lottery date among the lottery rights by a public lottery method or on-line lottery method. (S250) When the winning number is decided, the server refers to the database of the lottery right having a lottery number that coincides with the winning number. Thus, by referring to the purchaser field of the database of the winning lottery right, it becomes possible to know address and contact phone number of the winner.

From the above information, the server publicly announces the winner in the corresponding product corner. Also, the server delivers the corresponding product to the address of the winner, so that the lottery type sale is accomplished. (S260)

In the lottery type selling method using the foregoing basic virtual shopping mall, products to be registered at the virtual shopping mall can be decided from reflection of various opinions. In other words, if a product voting corner by the consumer is made in the virtual shopping mall, the consumer connected to the product voting corner through the consumer's terminal transmits a list of the consumer's desirable products, and the server stores the information transmitted from the consumer's terminal in the storage unit. (S310) For instance, consumers can transmit a notebook computer manufacturer's name and model that they most wish to buy to the server of the virtual shopping mall through their terminals. (S320 and S330) After the consumers' vote has been completed within a constant period, the server analyzes the voting result stored in the storage unit, decides a product that acquires the most voting rate, and can register this product at the virtual shopping mall. (S340) Thus, the most popular product to the consumers is registered at the virtual shopping mall, thereby enhancing the sales possibility of the product.

The virtual shopping mall established on the server can be managed on membership basis. A consumer who frequently uses the virtual shopping mall may be inconvenienced because whenever the consumer visits the virtual shopping mall, the consumer has to input name, resident registration number, and settlement method. Accordingly, this inconvenience can be removed by registering the consumer as the member of the virtual shopping mall, and allowing the purchase of the lottery right by filling only the name and ID of the registered member when the member wishes to buy the lottery right. Also, because an operator of the virtual shopping mall can effectively manage the consumer's information, the operator analyzes an advertisement of the virtual shopping mall or the consumer's taste on a specific product to thereby make a target advertisement at a low price. For this purpose, when the consumer requests to enter the membership, the virtual shopping mall of the server creates the membership database at the storage unit. The server fills information transmitted from the consumer's terminal, such as the consumer's name, address, contact phone number, settlement method, ID, password, and the like in the field of the created membership database. If there is a purchased lottery right or a winning lottery right in the virtual shopping mall, the server fills them in the lottery right purchaser breakdown field and the winning breakdown field of the membership database.

Further, the virtual shopping mall can manage these memberships as a free membership and a pay membership. In case of the pay membership, the server sells the lottery right at a discounted price, or can assign a compensatory lottery right to the corresponding membership free of charge when by comparing the lottery right purchaser breakdown of the membership database with the winning breakdown, the winning rate does not arrive at a prescribed reference winning rate.

The virtual shopping mall established on the server may rent the products to a manufacturer or a seller who wishes to sell the products. In other words, if the manufacturer or seller inputs name, address, contact phone number, types of sales products, rental period, rental range, rent, and the like to the server, the server creates a lessee database and then fills the forgoing information in the respective fields. If the lessee registers a product at the virtual shopping mall, the server creates and fills respective fields of the product database, publicly announces the corresponding product to the virtual shopping mall, and carries out the lottery type sale on the product.

In the step of selling the lottery right of the product on the virtual shopping mall, the purchaser may elect the number of the lottery rights. In other words, if there is a purchase request of the lottery right on the corresponding product, the server may request to transmit a desired number of lottery rights. With reference to the lottery right database of the corresponding product having the transmitted lottery number, the server requests to transmit a new number of lottery rights if the lottery right of the first requested number has been already sold, while the server sells the lottery right of the number to the purchaser if the lottery right of the first requested number is not yet sold. Thus, the consumer can purchase a desired number of lottery rights.

As described previously, it is possible to sell products in lottery type through the virtual shopping mall. Hereinafter, there is described operation of one embodiment in accordance with the present invention with reference to the accompanying drawings.

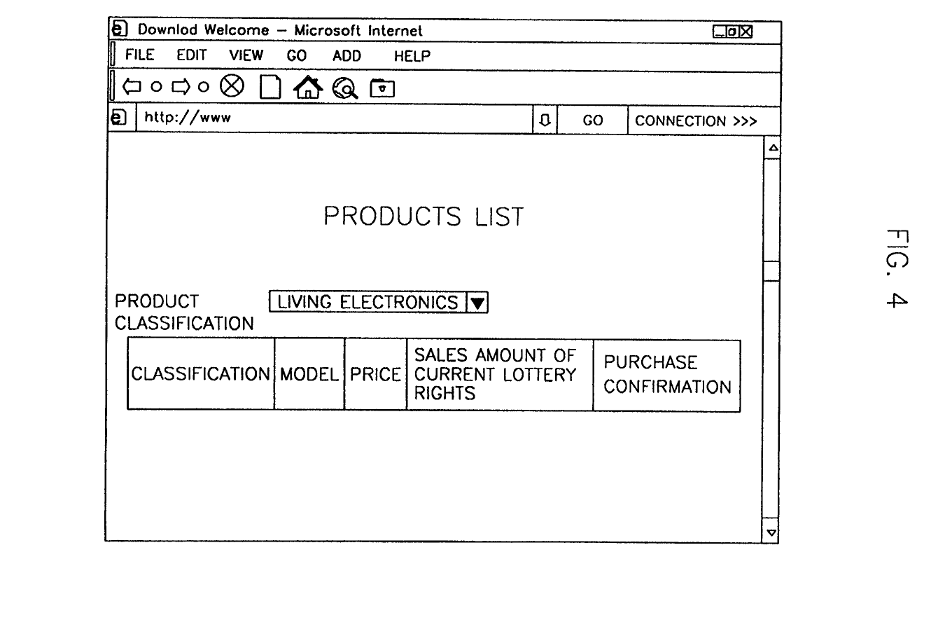

FIG. 4 is one example of a picture of displaying a product registered at the virtual shopping mall on the consumer's terminal connected to the server. Through this picture, the consumer can confirm product classification, model, price, issuance amount of lottery rights, price of lottery right, and sales amount of current lottery right. Also, through this information, the consumer decides whether or not to purchase the lottery right on the product. If the consumer decides to purchase the lottery right, the consumer can apply for the purchase by clicking a purchase confirmation button.

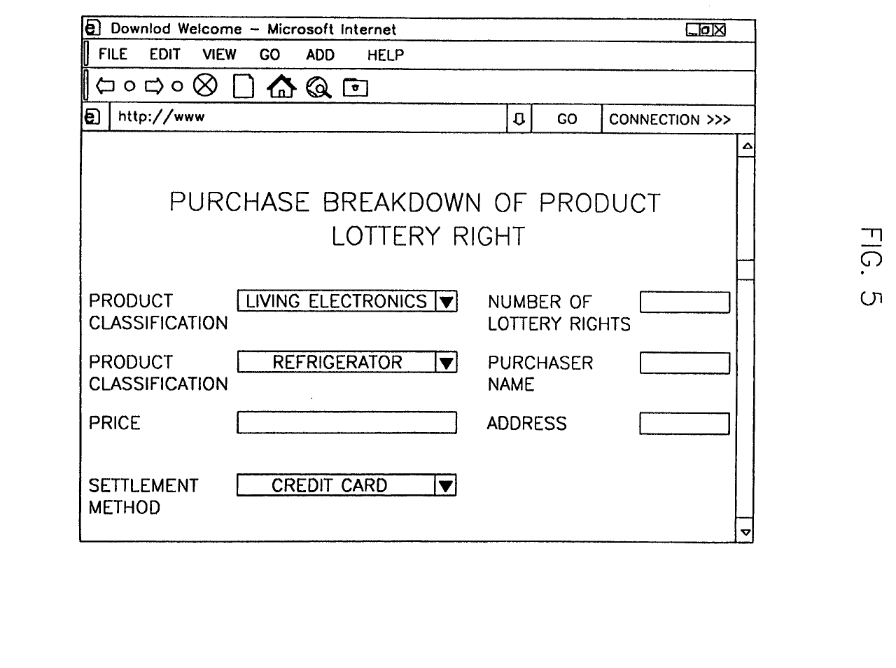

If the purchase confirmation button is clicked, a purchase application of the product lottery right is displayed on the consumer's terminal as shown in FIG. 5. The consumer inputs information necessary for the purchase of the lottery right, such as name, address, settlement method and the like in the picture of FIG. 5.

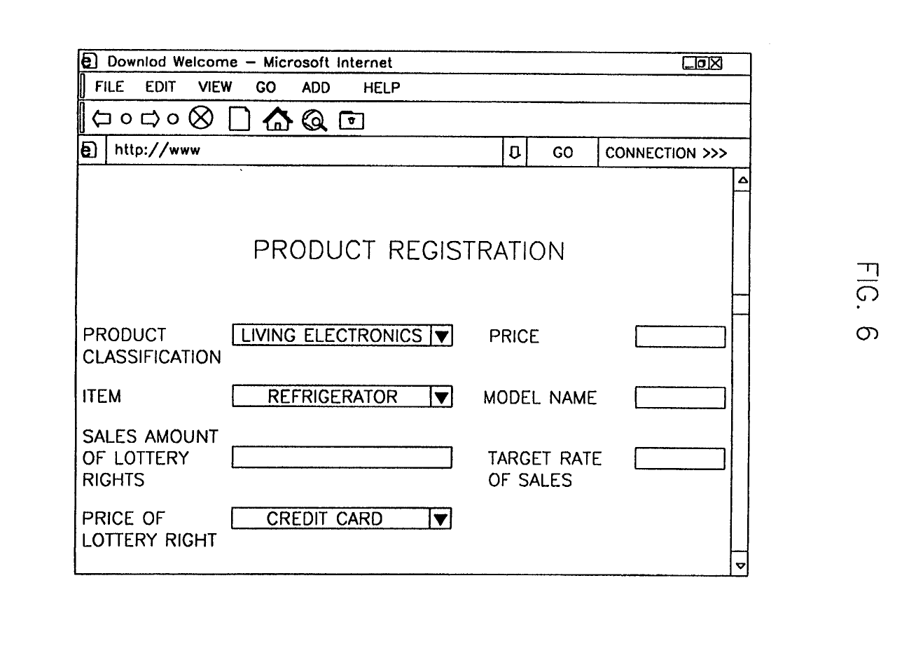

FIG. 6 is a schematic view showing one embodiment of a picture that is displayed on the server upon registering a product at the virtual shopping mall. The operator of the virtual shopping mall inputs product classification, item, price, model name, issuance amount of lottery rights, targeted sales rate and the like, and thereby the operator registers a specific product at the virtual shopping mall.

This invention has been described above with reference to the aforementioned embodiments. It is evident, however, that many alternative substitutions, modifications and variations will be apparent to those having skills in the art in light of the foregoing description. Accordingly, the present invention embraces all such alternative modifications and variations as fall within the spirit and scope of the appended claims.

### INDUSTRIAL APPLICABILITY

As described above, the present invention establishes a virtual shopping mall, thereby decreasing a merchandise distributing cost, and also can provide consumers with an opportunity capable of purchasing a high price product through a low price lottery right. Further, the invention not only decreases costs taken in events or free gifts supply for the purpose of sales promotion due to deepening of competition in the electronic commerce, but also reinforces the competitiveness of the electronic commerce.

Furthermore, the selling method of the present invention activates deals to thereby enhance national competitiveness and promote enterprises activities.

Moreover, the present invention collects memberships, can provide a purchase environment suitable for respective memberships, and can attract many foreign buyers through the Internet or the like, so that there can be anticipated an opportunity to earn foreign currency and a natural export effect of local products. Resultantly, the present invention is useful.

1. A lottery type selling method, the method comprising the steps of:
establishing a virtual shopping mall on a server;
registering a sales product at the virtual shopping mall;
selling a lottery corresponding to the product through a consumer's terminal connected to the server through a communication network;
confirming whether or not a total sales amount of the lottery corresponding to the products arrives at a target amount at the server;
if it is confirmed that the total sales amount arrives at the target amount, stopping the sale of the lottery and publicly announcing a lottery date;
carrying out the lottery for the corresponding product and publicly announcing a winner; and
delivering the product to the winner.

2. The method of claim 1, further comprising a step of deciding the product to be registered at the virtual shopping mall using an on-line vote through consumers' terminals connected to the server.

3. The method of 1, further comprising the steps of:
recruiting a member of the virtual shopping mall;
establishing a database for each of the members; and
providing a service including a discounting service of the lottery price and a supply service of a compensatory lottery right depending on data of the member.

4. The method of claim 1, further comprising a step of renting the virtual shopping mall established on the server to a product manufacturer or other sales agent.

5. The method of claim 1, wherein the step of selling the lottery comprises a step of allowing the consumer to select a number of lottery chances.

6. A lottery type selling apparatus comprising:
a product database including product information of a virtual shopping mall;
a lottery database including lottery information of each of products;
a storage unit for storing a consumer database including information related to a lottery purchaser; and
a server including a means for establishing and managing the virtual shopping mall, selling the lottery according to a purchase request transmitted from a consumer's terminal, and a means for confirming a sales amount of the lottery corresponding to the product, when the sales amount of the lottery arrives at a target amount, stopping sales of the lottery, and publicly announcing a lottery date,
wherein the consumer's terminal includes a means for transmitting information including the purchase request, and a means for receiving information from the server and displaying the information.

7. The apparatus of claim 6, wherein the storage unit further comprises a means for storing a vote result of the consumers transmitted from the consumers' terminals, and the server further comprises a means for receiving vote information on the sales products from the consumer's terminal and processing the received vote information to decide a sales product.

8. The apparatus of claim 6, wherein the storage unit further comprises a means for storing a membership database including membership information of the virtual shopping mall, and the server further comprises a means for recording the membership information transmitted from the consumer's terminal at the membership database, and deciding whether to discount a lottery sales price or to supply a bonus lottery chance depending on the membership database information.

9. The apparatus of claim 6, wherein the storage unit further comprises a means for storing lessee database information including lessee information of the virtual shopping mall, and the server further comprises a means for registering the lessee of the virtual shopping mall and allowing the lessee to register the product at the virtual shopping mall.
